(19) United States
(12) Patent Application Publication
(10) Pub. No.: US 2015/0356099 A1
(43) Pub. Date: Dec. 10, 2015

(54) NEIGHBORHOOD SIMILARITY TOOL AND METHOD

(71) Applicant: Walk Score Management, LLC, Seattle, WA (US)

(72) Inventors: Tony Targonski, Seattle, WA (US); Matthew R Lerner, Seattle, WA (US); David M Alber, Seattle, WA (US); Joshua R Herst, Seattle, WA (US)

(21) Appl. No.: 14/732,538

(22) Filed: Jun. 5, 2015

Related U.S. Application Data
(60) Provisional application No. 62/008,490, filed on Jun. 5, 2014.

(51) Int. Cl. G06F 17/30

(52) U.S. Cl. CPC G06F 17/3087; G06F 17/30241; G06F 17/3053

(57) ABSTRACT

Embodiments of the disclosure are directed towards a neighborhood similarity tool and method for comparing two locations based on metrics relevant to characteristics that create a unique character for the first location and the second location. The characteristics include features reflecting location similarity and features reflecting home amenity similarity. The neighborhood similarity tool generates a similarity assessment that is provided for graphically displaying the similarity between two locations.

### RELATED APPLICATIONS

This application claims priority under 35 U.S.C. Section 119(e) to U.S. Provisional Application Ser. No. 62/008,490 filed Jun. 5, 2014, entitled “Neighborhood Similarity” the disclosure of which is hereby incorporated by reference herein in its entirety.

### BACKGROUND AND SUMMARY

Each year, more than 35 million people in the United States move to a new location. People move to find new or cheaper housing, for employment, to be closer or farther from family members, and the like. People are often moving from a familiar place to a less familiar place. Currently, some real estate apps and websites recommend similar properties based on price, bedrooms, square footage, price per square foot, year built, and other aspects of the home.

The neighborhood similarity tool and method disclosed in the present application recognizes that addresses, neighborhoods, and cities vary on many dimensions. By analyzing key features of locations that are outside of the four walls of a home, the neighborhood similarity tool improves upon the current techniques and increases the accuracy of recommendations for identifying homes, apartments, hotels, vacation rentals, and the like when moving, temporarily relocating, or traveling.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a functional block diagram representing a computing device suitable for use for the neighborhood similarity tool;

FIG. 2 is a flow diagram illustrating an exemplary process for comparing neighborhood similarity between two or more locations suitable for use in the component illustrated in FIG. 1;

FIG. 3 is an example screen display illustrating an example user interface element operable to input selections that adjust an area encompassing the location used for comparing neighborhood similarity in FIG. 2;

FIG. 4 is an example screen display illustrating an area encompassing the location used for comparing neighborhood similarity in FIG. 2;

FIGS. 5-9 illustrate example metrics for use in the process illustrated in FIG. 2;

FIG. 10 is a flow diagram illustrating an exemplary process for determining a metric based on social media that is suitable for use in FIG. 2;

FIG. 11 illustrates an example visual representation of a social media metric suitable for use in the process illustrated in FIG. 2;

FIG. 12 is a flow diagram illustrating an exemplary process for comparing two locations for similarities; and

FIGS. 13-17 illustrate example visual representations of results of the neighborhood similarity process illustrated in FIG. 2.

### DETAILED DESCRIPTION

The following disclosure describes a neighborhood similarity tool and method for detecting locations that are similar to each other, thereby improving the accuracy of recommendations for homes, apartments, vacation rentals, travel lodging, and the like. In furtherance of this tool, characteristics or features have been determined that provide unique character to a place. These characteristics or features may be grouped into categories and analyzed when comparing different locations for neighborhood similarity. In some embodiments, the neighborhood similarity tool may be provided as a network accessible application, such as a web page specified by a Uniform Resource Locator (URL) and displayable via a web browser, or, may be provided via a server or as a web service and integrated into another third party application.

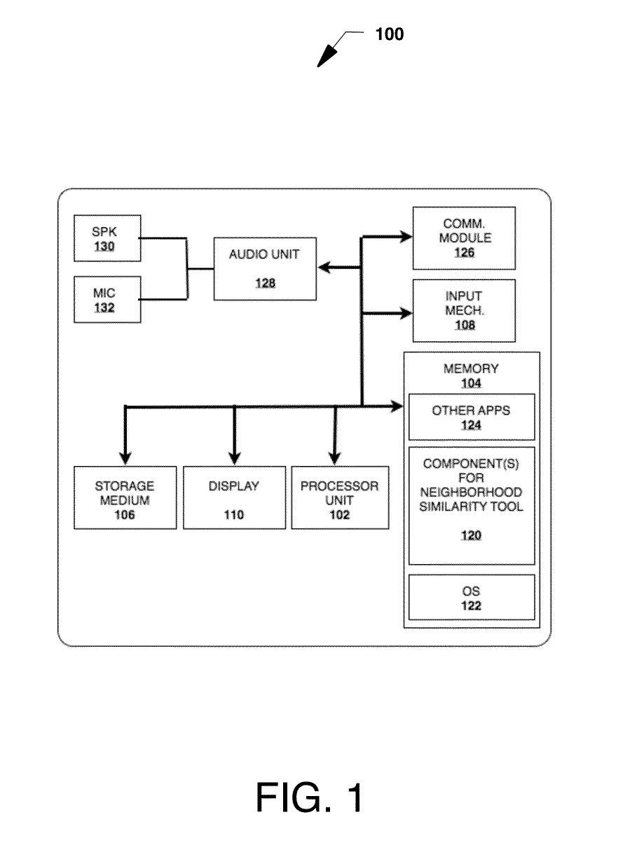

FIG. 1 is a functional block diagram representing a computing device suitable for use for the neighborhood similarity tool. The computing device 100 may include various types of computing systems. For example, in some embodiments, the computing device may be a desktop computing system executing a Web browser that may be used by a user to interactively obtain information from the neighborhood similarity tool. In some other embodiments, the computing device may be a mobile computing device (e.g., a mobile phone, tablet, phablet) having location aware functionality (e.g., a GPS system). The GPS-capable mobile computing device may provide an indication of the current location of the mobile computing device to the neighborhood similarity tool which may be used when comparing two locations. In other embodiments, the computing device may be a one or more servers performing the neighborhood comparison and providing results to a desktop computing system or mobile computing device. The computing device 100 includes a processor unit 102, a memory 104, a storage medium 106, an input mechanism 108, and a display 110. The processor unit 102 advantageously includes a microprocessor or a special purpose processor such as a digital signal processor (DSP), but may in the alternative be any conventional form of processor, controller, microcontroller, state machine, or the like.

The processor unit 102 is coupled to the memory 104, which is advantageously implemented as RAM memory holding software instructions that are executed by the processor unit 102. These software instructions represent computer-readable instructions and computer executable instructions. In this embodiment, the software instructions stored in the memory 104 include components (i.e., computer-readable components) for a neighborhood similarity tool 120, a runtime environment or operating system 122, and one or more other applications 124. The memory 104 may be on-board RAM, or the processor unit 102 and the memory 104 could collectively reside in an ASIC. In an alternate embodiment, the memory 104 could be composed of firmware or flash memory. Depending on the computing device 100, different groupings of the components for the neighborhood similarity tool 120 may reside on the device 100. For example, the components 120 residing on a mobile computing device may differ from the components 120 residing on a server.

The storage medium 106 may be implemented as any nonvolatile memory, such as ROM memory, flash memory, or a magnetic disk drive, just to name a few. The storage medium 106 could also be implemented as a combination of those or other technologies, such as a magnetic disk drive with cache (RAM) memory, or the like. In this particular embodiment, the storage medium 106 is used to store data during periods when the computing device 100 is powered off or without power. The storage medium 106 could be used to store metrics used during the similarity calculation, such as population density, walk score metric, median income, crime score metric, and the like. It will be appreciated that the functional components may reside on a computer-readable medium and have computer-executable instructions for performing the acts and/or events of the various method of the claimed subject matter. The storage medium being on example of computer-readable medium.

The computing device 100 also includes a communications module 126 that enables bi-directional communication between the computing device 100 and one or more other computing devices. The communications module 126 may include components to enable RF or other wireless communications, such as a cellular telephone network, Bluetooth connection, wireless local area network, or perhaps a wireless wide area network. Alternatively, the communications module 126 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 128 may be a component of the computing device 100 that is configured to convert signals between analog and digital format. The audio unit 128 is used by the computing device 100 to output sound using a speaker 130 and to receive input signals from a microphone 132. The speaker 132 could also be used to announce incoming calls.

A display 110 is used to output data or information in a graphical form. The display could be any form of display technology, such as LCD, LED, OLED, or the like. The input mechanism 108 includes keypad-style input mechanism and other commonly known input mechanisms. Alternatively, the input mechanism 1208 could be incorporated with the display 1210, such as the case with a touch-sensitive display device. Other alternatives too numerous to mention are also possible.

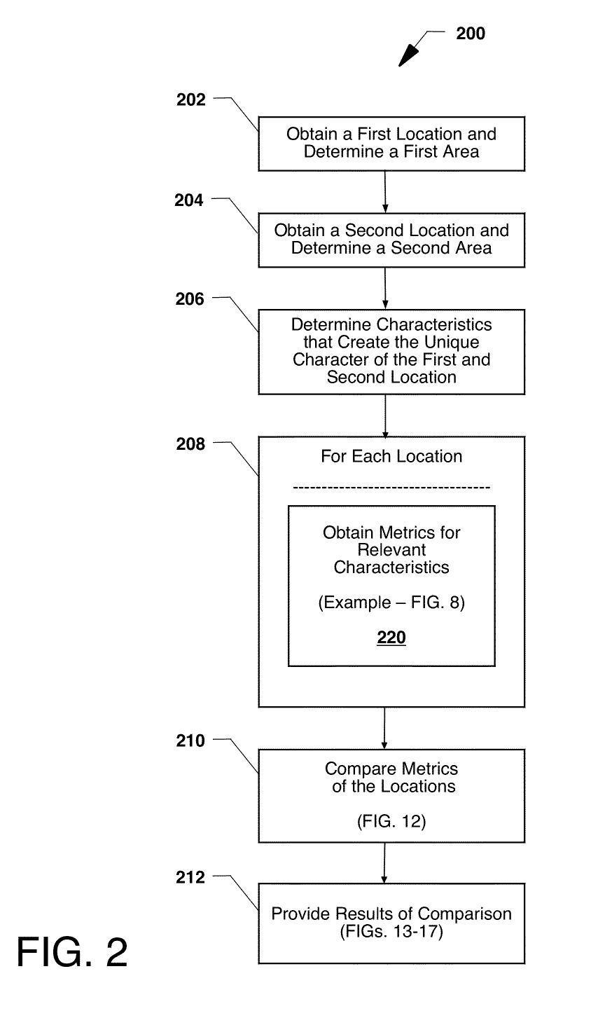

FIG. 2 is a flow diagram illustrating an exemplary process 200 for comparing neighborhood similarity between two or more locations suitable for use in the component illustrated in FIG. 1. At block 202, a first location is obtained and a first area associated with the first location is determined. Broadly, locations may be divided into two categories: addresses (e.g., point locations) or areas (e.g., neighborhoods, cities, counties, states, census blocks or block groups, physical blocks, etc.). The first location may be obtained by any suitable manner, such as an explicit entry into a field on a web page by a user. The location may be specified as a physical address, a latitude/longitude, an indication on a map, or the like. A location may also be implicitly obtained, such as by a GPS capable device in possession of the user. For example, a portion of the neighborhood similarity tool may be implemented within a mobile application stored on a user's mobile phone. Upon launch of the mobile application, the mobile application may detect the current location and compare that location against the stored home location, and automatically select similar locations to visit in a new city. This manner of obtaining a first location may be useful when traveling or shopping for a new home. In other embodiments, a GPS-capable mobile phone may periodically (e.g., every minute) provide an indication of the current location of the mobile phone which can then be used to obtain an address and display a continuously updated result on similar neighborhoods.

When determining the similarity of two or more addresses or point locations, process 200 determines how much of the area to compare between the locations. A simple radius may be used to compare the area between addresses, but the inventors of the present technique have found that a walk shed area (the area reachable in a certain amount of walking time) yields a more accurate comparison between places. Techniques described in U.S. application Ser. No. 13/587,680 filed on Aug. 16, 2012, entitled “System and Method for the Calculation and Use of Travel Times in Search and Other Applications” may be used to determine the “walk shed” and is hereby incorporated by reference in its entirety. When determining the similarity of areas, process 200 determines the area, such as a neighborhood or city, that is used for comparing places. For example, all of the neighborhood areas in one city could be compared against all of the neighborhood areas of another city.

At block 204, a second location is obtained and a second area encompassing the second location is determined. As described above in block 202, the second location may be obtained by any suitable manner. Likewise, the second area may be determined as described above. Typically, the first area and the second area may be determined using similar methods, however, this is not required. While process 200 is illustrated as comparing two locations, one skilled in the art will appreciate that multiple locations may be compared in bulk or batch form without departing from the claimed invention. In addition, one or more of the locations may have been previously stored, such as a home location associated with a mobile device.

At block 206, characteristics that create the unique character for the identified locations are determined. The characteristics may be grouped into categories, such as a built environment category, a people and jobs category, a social media and reviews category, and the like. Each of the categories may have any number of features related to the category. The built environment category may include features related to human-made space in which people live, such as buildings, transportation, home prices, rents, and the like. The people and jobs category may include the types of people who live and work in a neighborhood, which will aid in determining the character of a neighborhood. The social media and review category may include interesting information about the character of a neighborhood that may be obtained from social media, such as from TWITTER services, FOURSQUARE services, GOOGLE PLUS services, YELP services, and the like. Those skilled in the art will appreciate that other categories may be added or one of the afore-mentioned categories may be removed without departing from the scope of the claimed invention. In addition to these location similarity features, home amenity similarity features may be determined, such as the number of bedrooms, square footage, and the like.

At block 208, each location is processed. Processing may occur dynamically or may use stored values from prior processing, such as if the location is a home address that is used quite often. At block 220, metrics are obtained. The metrics may be based on a score that can be obtained from another source, data obtained from another source, generated data based on data obtained from one or more sources, data obtained from sensor technology, data aggregated from social media, and the like. These metrics provide some type of measure that can used to compare two or more different locations. Each metric provides at least one of the dimensions in the multi-dimensional comparison of two locations. The following describes some example metrics that may be used in different categories.

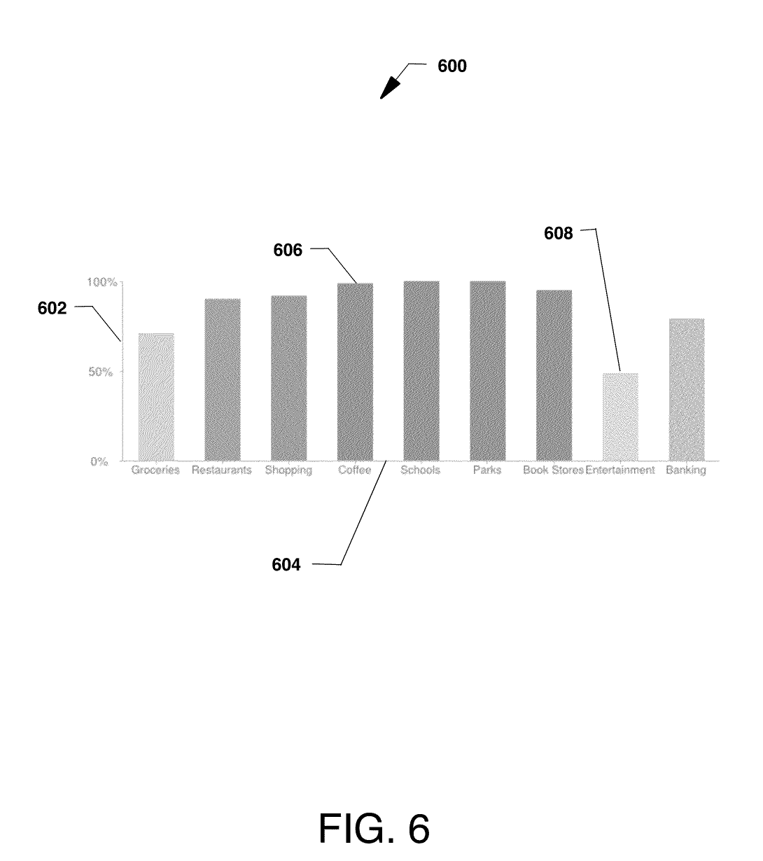

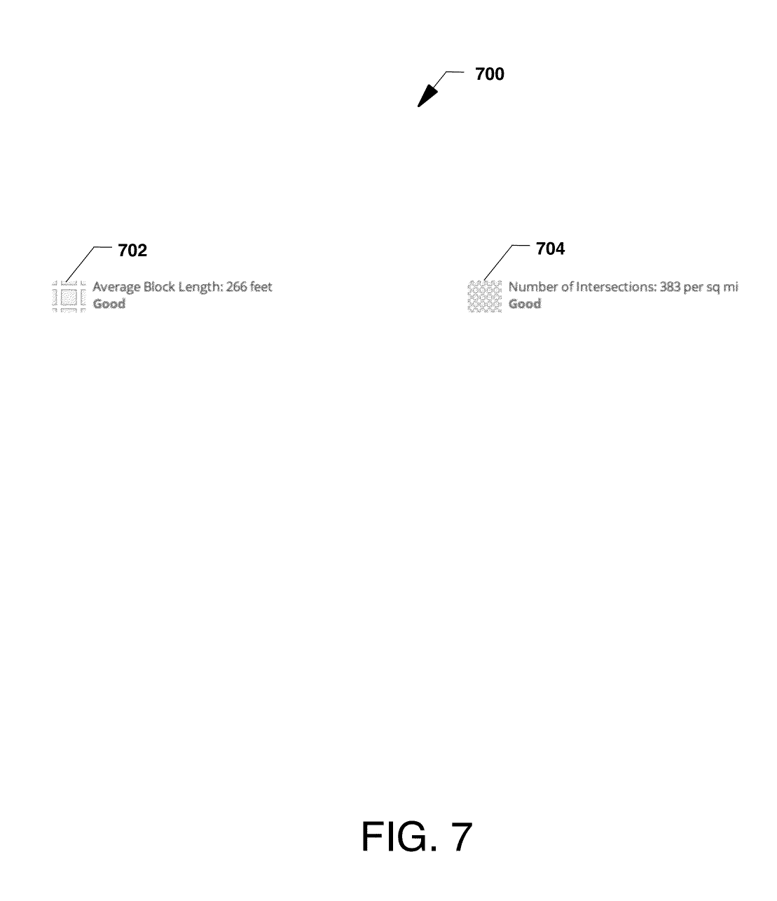

In the built environment category, metrics may include one or more of the following measures: 1) a measure of a proximity of amenities (businesses, parks, schools, etc) to an identified address or area; 2) a measure of how well an address or area is served by public transit (e.g., types of transit routes, frequency, and proximity to those routes); 3) a measure indicating bike-ability for a location (e.g., bike lanes or paths, the number of bike commuters); 4) a measure indicating a number and type of business, a number and type of transit lines, a number of car or bike shares, and the like; 5) a measure of building characteristics (e.g., age of buildings, heights, lot sizes, average or median home prices or prices per square foot, average or median rents per bedroom or per square foot, and other information related to buildings near a location; 6) a measure based on analysis of locations, such as types of businesses (e.g., retail versus restaurants versus industrial), price ranges of those businesses, number or area of parks, percentage of one type of restaurant versus another type, price range, rating, and/or review; 7) a measure indicating an average block length (e.g., does a neighborhood have short pedestrian friendly blocks or longer blocks), intersection density (high intersection density is more pedestrian friendly), speed limits, road width, sidewalks; 8) a measure indicating a distance to a city center or other commercial districts (e.g., neighborhood center) for differentiating between close-in (e.g., close to downtown or commercial districts) and fringe (further from downtown) neighborhoods; and 9) a measure indicating levels of traffic and congestion along roads near an address or in an area. These and other metrics may be used in determining neighborhood similarity. For example, if congested road speed is on average 90% of the free-flow traffic speed in one neighborhood but it is only 10% of the free-flow traffic speed in another neighborhood, those neighborhoods may be considered dissimilar. FIGS. 6 and 7, described later, illustrate example metrics for the built category.

In the people and job category, metrics may include one or more of the following measures: 1) a measure indicating demographics (e.g., population density, age, gender, commute times, transportation preferences, and the like); 2) a measure indicating jobs (e.g., the number of jobs near an address or in an area, the types of jobs, income for the jobs, commute times for the jobs, and the like); 3) a measure indicating crime rates and types of crimes; and 4) a measure indicating noise volume, frequency, and the like. The data for determining these metrics may be obtained from various sources. For example, the United States Census or other entities and businesses may provide data for obtaining demographics metrics. In addition, E. G. Esri provides “tapestry segments” with detailed demographic information that may be used. The Longitudinal Employer-Household Dynamics (LEHD) from the United States Census may provide data for obtaining job metrics. FIGS. 6 and 7, described later, illustrate example metrics for the people and job category.

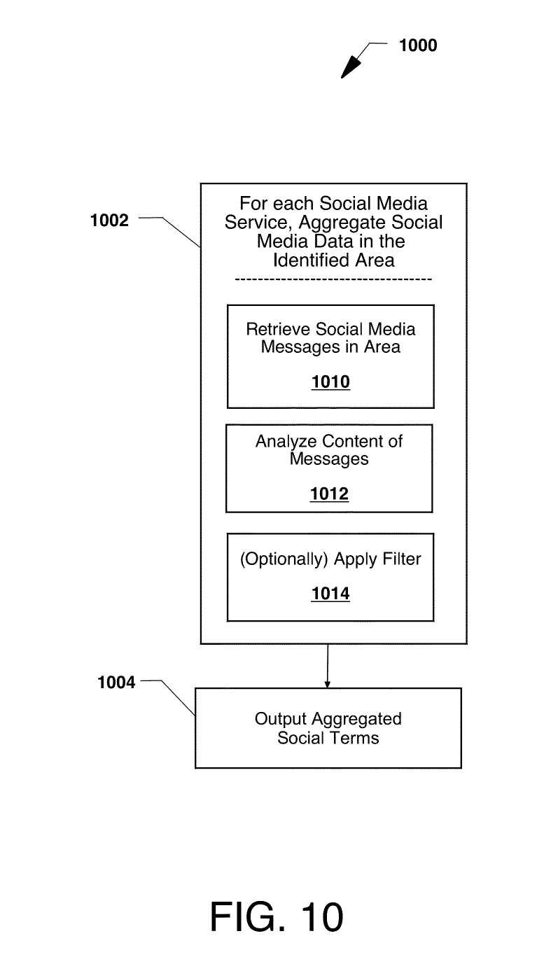

In the social media and reviews category, metrics may include a measure indicating an aggregation of social media terms from messages near a location to determine the most common words, topics, or phrases. FIG. 10, described later, illustrates a process 1000 for determining a metric from social media and reviews category.

At block 210, the metrics obtained for each of the locations are compared in a meaningful manner. This may involve further normalization of the metrics if the locations being compared differ greatly in certain characteristics. For example, two neighborhoods might have very similar metrics related to the built environment category but have different metrics related to people and jobs. In another example, two neighborhoods may have a very similar built environment and population but one neighborhood might have older vs. newer buildings or higher vs. lower incomes. The difficulty is determining the similarity of places when the locations vary on many dimensions. In overview, there are a number of well-established mathematical and statistical techniques for determining pairwise distance between multidimensional data points including Euclidean distance, squared Euclidean distance, Manhattan distance, and Cosine similarity. These distance functions compute a numerical value that can be used to determine how “close” two multidimensional points are. Distance functions are one of the parameters used by clustering algorithms.

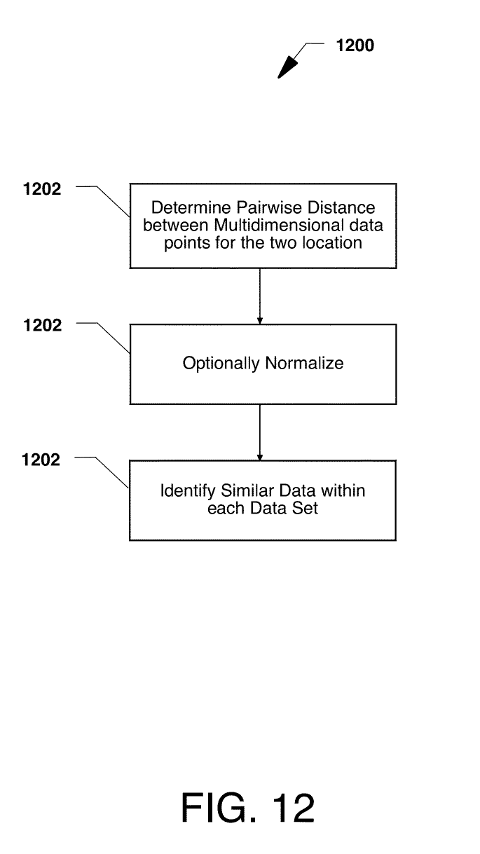

Clustering algorithms identify clusters among complex data, and the computed clusters indicate which items in a dataset are similar. The selection of a clustering algorithm is tied closely to the data being clustered. For the problem of determining location similarity, potentially applicable approaches include hierarchical clustering algorithms, centroid-based algorithms, and density-based clustering algorithms. Specific examples from these classes of algorithms include the k-means algorithm, DBSCAN, and OPTICS. FIG. 12, described later below, is a flow diagram illustrating an exemplary process for comparing two locations for similarities.

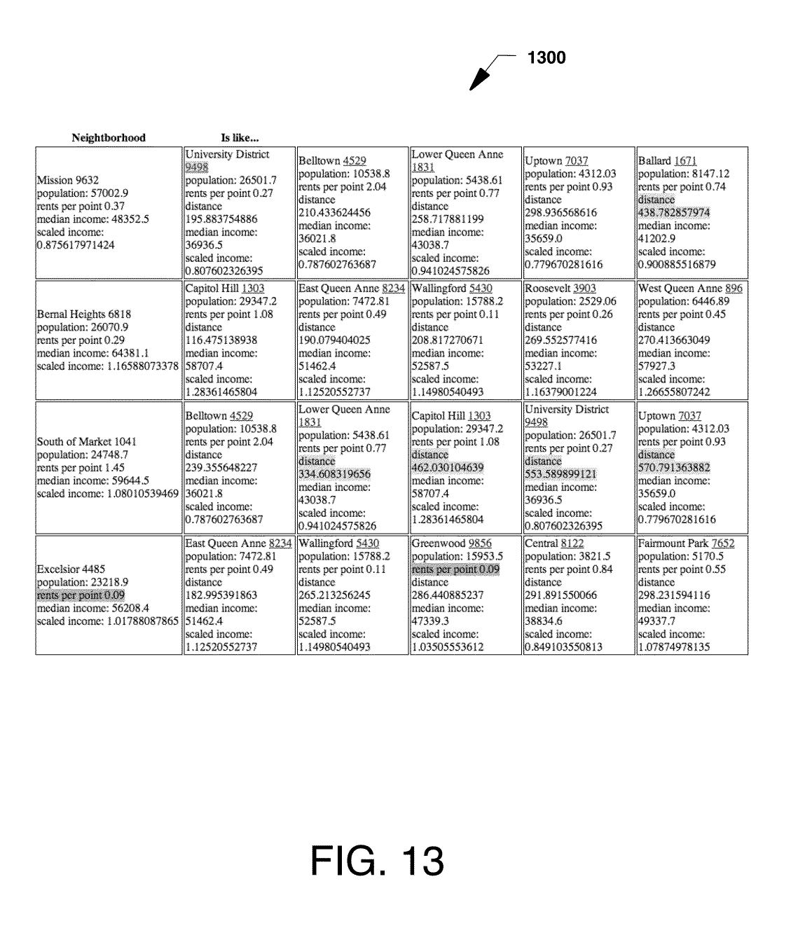

At block 212, results from the comparison of metrics are provided. The results then indicate the neighborhood similarities between two or more locations. As mentioned above, the results improve the accuracy of recommendations for homes, apartments, vacation rentals, travel lodging, and the like. FIGS. 13-17, described later, illustrate example results.

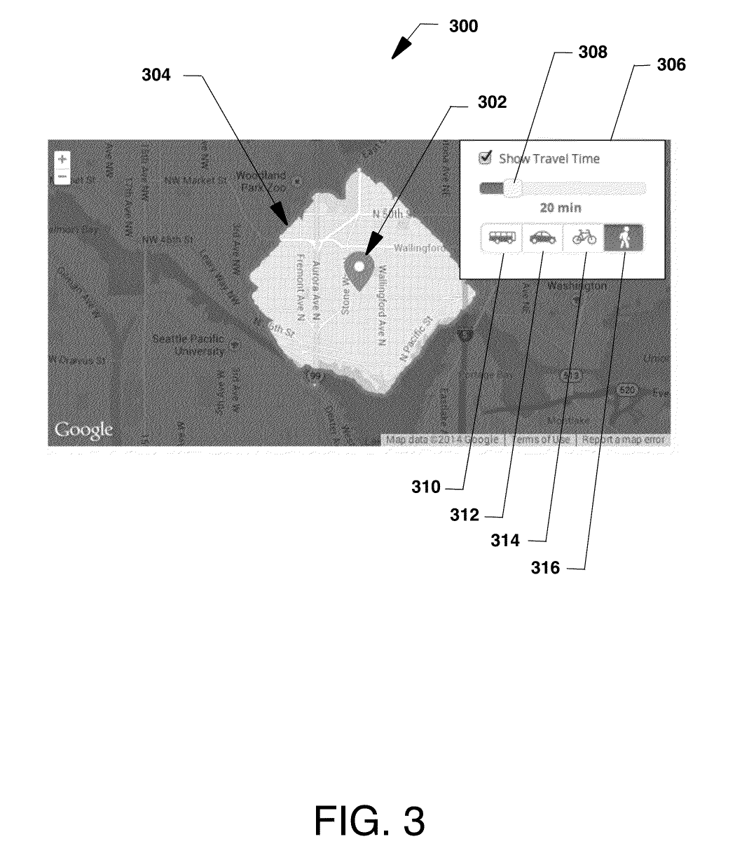

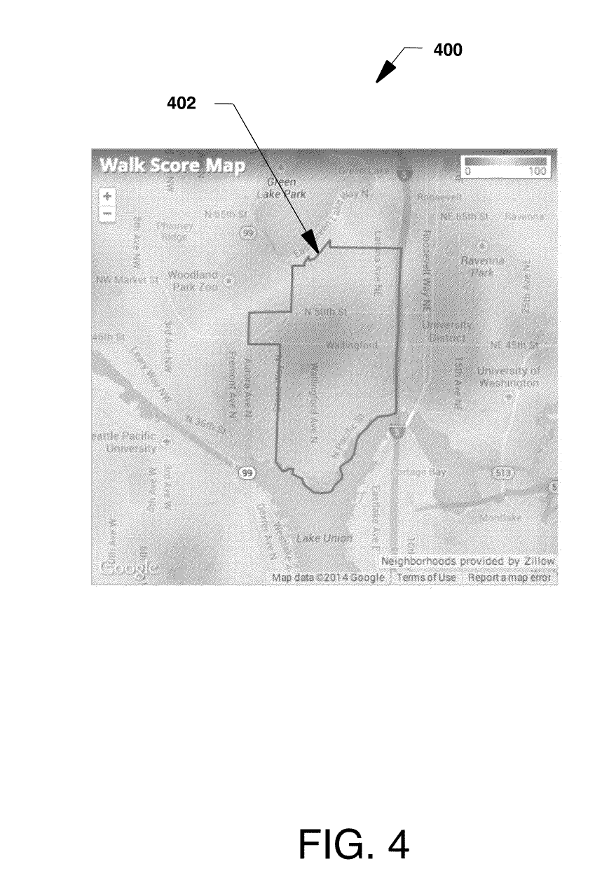

As briefly discussed above, two example techniques for obtaining an area associated with a location are illustrated in FIGS. 3 and 4. FIG. 3 is an example screen display 300 illustrating an example user interface element 306 operable to selectively adjust an area 304 that encompasses a location 302. The user interface element, in this example, includes a slider 308 which allows a user to set a corresponding travel time. In addition, the user interface element includes mode selectors 310-316 for selecting a mode, such as public transportation 310, driving 312, biking 314, or walking 316. The area 304 then adjusts interactively with the selections. FIG. 4 is an example screen display 400 illustrating an area 402 based on a predetermined boundary, such as a neighborhood, a city boundary, or other arbitrary shape.

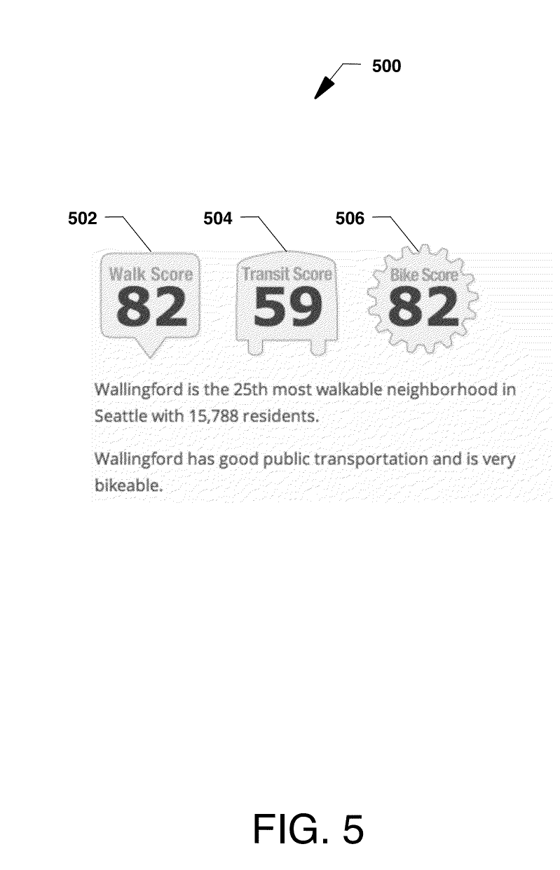

FIGS. 5-7 illustrate example metrics for the built environment category. FIG. 5 illustrates a walk score metric 502, a transit score metric 504, and a bike score metric 506. Techniques described in U.S. Pat. No. 8,892,455 filed on May 7, 2008, entitled “Systems, Techniques, and Methods for Providing Location Assessments” may be used to determine the walk score metric 502, transit score metric 504, and bike score metric 506. In overview, the walk score metric 502 takes into account several features that affect the ability to walk within a neighborhood. The transit score metric 504 takes into account several features that affect the ability to travel within the neighborhood using public transportation services. The bike score metric 506 takes into account several features that affect the ability to ride a bicycle within a neighborhood. FIG. 6 illustrates a bar chart showing a metric for types of businesses found near a location (e.g., an address, neighborhood, city, etc). The bar chart 600 includes a y-axis 602 indicating a percent of score attainment and an x-axis 604 for indicating types of businesses. Multiple bars (e.g., bars 606 and 608) are displayed along the x-axis at various heights. Each bar represents a category assessed in computing a walk score metric. Each category has a maximum number of points (i.e., a sub-score) that can be contributed to the walk score metric. The height of the bar indicates the percent of the sub-score earned for the associated category. For example, bar 606 represents coffee and indicates that roughly 90% of the maximum possible sub-score for that category has been earned. Whereas bar 608 represents entertainment and indicates that roughly 45% of the maximum sub-score for entertainment has been earned at this location. The bar chart 600 allows individuals to readily interpret whether the location has the types of businesses and/or amenities in which they are interested. FIG. 7 illustrates a graphical output 700 showing a metric for road network analysis (e.g., average block length 702, number of intersections 704, and the like).

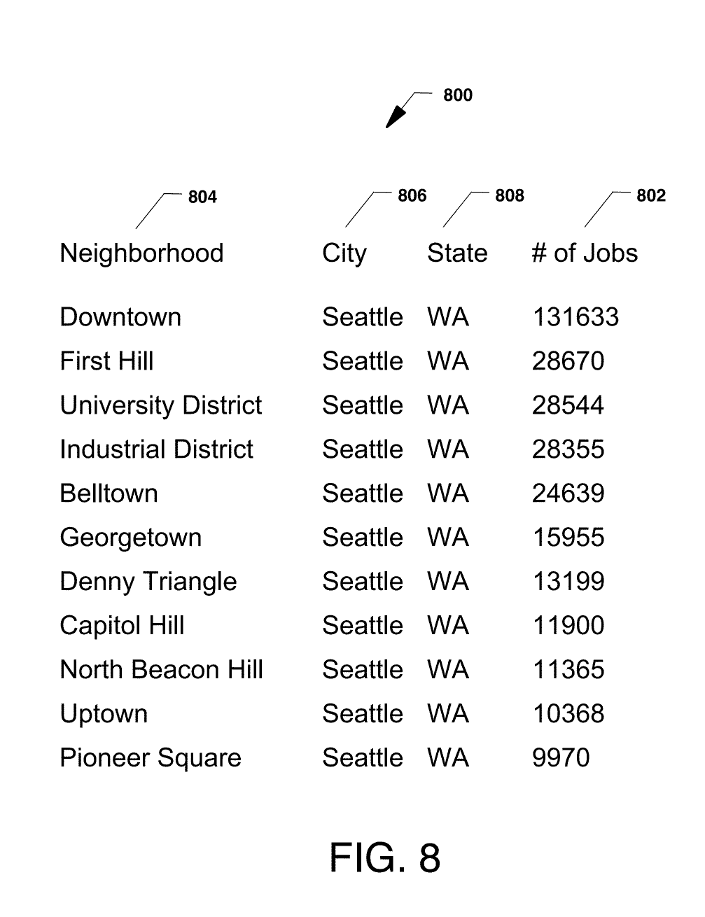

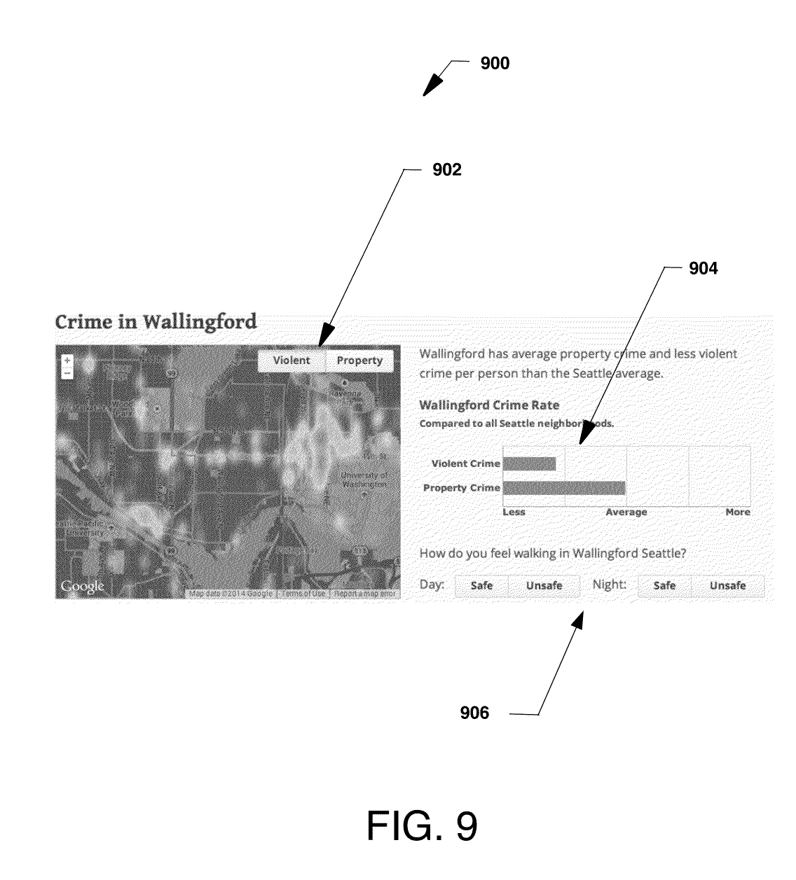

FIGS. 8-9 illustrate example metrics for the people and jobs category. FIG. 8 illustrates a job metric 800 indicating the number of jobs 802 in specific neighborhoods 804 in an identified city 806 in a corresponding state 808. The job metric 800 may be computed using census block-level jobs information from the LEHD Origin-Destination Employment Statistics dataset. FIG. 9 illustrates a crime metric 900. The crime metric 900 may include a crime heat map 902 graphically illustrating a varying degree of crimes in a specified area, a crime bar graph 904 indicating relative crime for an area compared to nearby neighborhoods, and a day and night safety graphic 906 illustrating how safe the specified area is during the day and night. In overview, the crime metric 900 takes into account several features that reflect the crime rate and seriousness of crimes within a neighborhood. The crime metric may determine accurate per capita rates across neighborhoods. In addition, the crime metric may reflect the types of crimes. Techniques described in U.S. patent application Ser. No. 14/331,073 filed on Jul. 14, 2014, entitled “Crime Assessment Tool and Method” may be used to determine the crime metric 900.

In the social media and reviews category, metrics may include a measure indicating an aggregation of social media terms from messages near a location to determine most common words, topics, or phrases. FIG. 10 illustrates a process 1000 for determining a metric from social media and reviews category.

At block 1002, the social media data occurring within a specified area is aggregated. For example, process 1000 may aggregate multiple social media messages near an address or in a neighborhood or city to determine which words, topics, or phrases occur most often in a neighborhood. If the location represents an address, process 1000 may look at social media messages within a “walk shed” (the area reachable in a certain time by walking) near an address. Social media APIs allow programmers to retrieve “Tweets”, “check ins”, or other social media data such as online reviews and ratings with their associated latitude and longitude. Social media data includes data retrieved from TWITTER services, FOURSQUARE services, GOOGLE PLUS services, YELP services, and the like. The following pseudocode demonstrates an example aggregation of social media phrases from TWITTER services.

TABLE 1
Pseudocode for Aggregation of Social Media Phrases

```
function getSocialTerms(area, n, minCount):
    tweetBodies = getTweets(area)
    userNgrams = { } // Map users to their n-grams
    for body in tweetBodies:
        if not body.author in filteredAuthors:
            userNgrams[body.author] += (makeNGrams(body,n))
        endif
    endfor
    countMap = makeCountMap(filterNGrams(userNgrams))
    removeCountsBelow(countMap, minCount)
    return countMap
```

At block 1010, social media messages are accessed. Retrieval of the social data is achieved by interacting with an API provided by the social media organization. For example, tweets that have occurred within the identified area are requested. In Table 1 above, a call to getTweets( ) is performed to get social media data occurring within the specified area.

At block 1012, the messages are analyzed. Statistical or sentiment analysis may be performed on the content of the social media messages. In some embodiments, authors of some tweets are filtered in order to avoid capturing automatically-generated tweets. In addition, in some embodiments, n-grams from a collection of tweets of a single user are aggregated together so that each unique n-gram from a user is counted only once. An n-gram is a set of n contiguous values from a sequence. For example, “method for” is a 2-gram of “system and method for discovering”. The makeNGrams( ) function above in the pseudocode from Table 1 returns all contiguous values size n or less from the input. For example, a call to makeNGrams (‘and pedestrians need quality’, 2) returns [‘and’, ‘pedestrians’, ‘need’, ‘quality’, ‘and pedestrians’, ‘pedestrians need’, ‘need quality’].

At block 1014, an optional filter may be applied to improve the quality of the analysis performed in block 1012. For example, in some embodiments, frequent posters such as bots may be filtered out or offensive information or non-interesting information may be filtered out. To ensure data quality, the output of makeNGrams( ) function may be filtered to return the unique set of n-grams from the input. In addition, a location associated with the messages may be determined. The function filterNGrams( ) removes elements from the input that contain certain strings that identified to be filtered. For example, some of the filtered strings may include mundane values like “the”, “of”, and “and”, as well as phrases that are not considered valuable or worth displaying to users, such as profanity. Instances of the filtered n-grams are counted to determine how many times an n-gram appeared across multiple tweets. Finally, n-grams appearing fewer than minCount times are removed from the list because they are not used commonly enough to constitute a trend in the area.

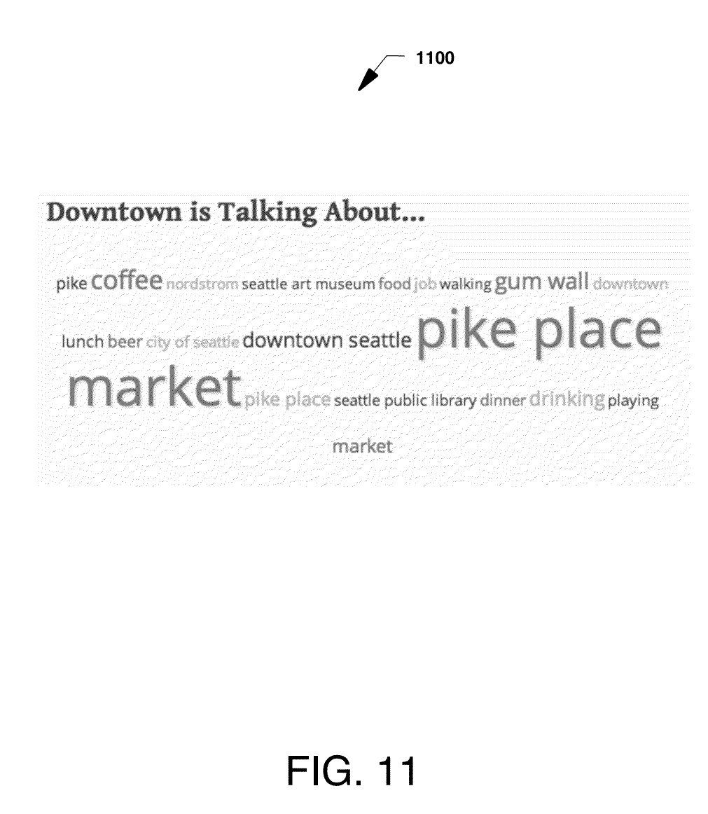

At block 1004, output from process 1000 may be provided. Continuing with the example for the pseudocode in Table 1 above, the results from getSocialTerms( ) function may be output to a user or may be provided to process 200 for further comparisons with other locations. For example, the output may be rendered on a display using a font size that is dependent on the number of times the n-gram was seen for an area. Briefly, turning to FIG. 11, which illustrates one example output in which a visualization of the social media messages is shown where the size of the text used for a corresponding word represents the frequency of use in the social media messages. Therefore, large sized words represent words appearing more frequently. In FIG. 11, a user may easily understand that pike place market, coffee, gum wall are the most frequently mentioned terms in social media messages based on the size of the text displayed for those terms. Using this information, a user may determine whether the location is of interest or not. In addition, this information provides another dimension to the neighborhood similarity tool when comparing two locations

The result from process 800 may also generate a metric indicating when a neighborhood is most active. For example, the result of the analysis may indicate whether a neighborhood is more active during the day, at night, or whether the area has a higher level of social media activity during all times. In one embodiment, for example, “Tweets” from the TWITTER service or “check-ins” from the FOURSQUARE service may be used to determine how active a neighborhood is. Social media activity may be normalized by the area contained by a neighborhood or the population within a given boundary, radius, or walk shed. In addition, sentiment analysis may be determined and used to detect a general “mood” of a neighborhood. For example, there are well-known algorithms and software packages that can infer sentiment from text, such as Python NLTK (Natural Language Tookit) and a text mining module for the statistical programming language R. The sentiment of social media in a neighborhood might be positive or negative, it might be happy, sad, angry, etc. During the comparison process of different locations, the present neighborhood similarity tool may use sentiment of neighborhoods to identify similarities with locations.

The social media metrics may then be combined with the metrics from other categories (e.g., built environment category, and people and job category). Once each location is analyzed to determine N dimensions for that location, comparisons between different locations may be performed to determine similarities.

FIG. 12 is a flow diagram illustrating a process 1200 for comparing two different locations. Process 1200 may perform a loop in which it repeatedly receives and processes similar neighborhoods based on updated location information. This may occur if a user is traveling or is house hunting and the user's mobile device updates the neighborhood similarity tool with new location information.

At block 1202, a pairwise distance between multidimensional data points for the two locations are determined. As discussed above, the difficulty with determining the similarity of locations is the numerous dimensions which may vary between the locations. There are a number of well-established mathematical and statistical techniques for determining pairwise distance between multidimensional data points including Euclidean distance, squared Euclidean distance, Manhattan distance, and Cosine similarity. These distance functions compute a numerical value that can be used to determine how “close” two multidimensional points are. Distance functions are one of the parameters used by clustering algorithms. Clustering algorithms identify clusters among complex data, and the computed clusters indicate which items in a dataset are similar. The selection of a clustering algorithm is tied closely to the data being clustered. For the problem of determining location similarity, the neighborhood similarity tool may apply hierarchical clustering algorithms, centroid-based algorithms, density-based clustering algorithms, or the like. Specific examples from these classes of algorithms include the k-means algorithm, DBSCAN, and OPTICS. Table 2 illustrates example pseudocode for calculating the squared Euclidean distance between all of the addresses in one city versus another city.

TABLE 2
Pseudocode for Calculating the Squared Euclidean Distance

```
function computeCityToCityAddressDistances(city1, city2) :
    distances = { } // Stores address-address distance mappings
    for address1 in city1.addresses:
        for address2 in city2.addresses:
          distance=computeLocationPairDistance(address1, address2)
          distances[address1 to address2] = distance
        endfor
    endfor
    return distances
function computeLocationPairDistance(location1, location2) :
    distance = 0
for property in additiveProperties :
    if property in location1 and property in location2:
        distance += scaledDifference(
            location1.property, location2.property
        )**2
    endif
endfor
for property in subtractiveProperties :
    if property in location1 and property in location2:
        distance −= propertyContribution(property)**2
return distance
```

In the pseudocode in Table 2, scaledDifference is a mathematical expression selected based on the property, and additiveProperties and subtractiveProperties are sets of metrics that are used to measure similarity, such as a walk score metric, a transit score metric, a population density metric, or the like. Subtractive properties are metrics that make the distance smaller (i.e. bring two addresses closer together). For example, each shared term that appears in the social data for a pair of addresses may be used to decrease the total distance. The amount by which the distance is decreased is controlled by the propertyContribution function, which can be tuned to provide the desired amount of impact for each type of property. In most cases the scaled difference is simply the difference between the property value for address1 and address2. Some types of property, however, may need to be normalized so that values contributed from different types of properties will be of similar magnitudes. For example, values for the walk score metric range from 0 to 100, whereas home values range from five-figure numbers to values in the millions. So that differences in home prices (differences potentially in the millions) do not eclipse walk score metrics (differences potentially in the tens), the neighborhood similarity tool normalizes home prices.

At block 1204, properties may be optionally normalized. In one embodiment, a softmax transformation may be applied. For example, for two home prices, p1 and p2, the following function for scaledDifference may be employed:
function softmax(p1, p2):
   return |p1−p2|/(p1+p2)
      The softmax function returns a value between zero and one. This can be subsequently scaled to span any desired range. If it is desired to have the home price difference be in a range from 0 to 50, the result of the softmax function may be multipled by 50, (e.g., 50*softmax(p1, p2)).

Normalization may be performed between cities too. As mentioned above, the different scales of metrics may require some normalization, using techniques like softmax, to get the desired effect. Metrics of the same type across cities may also differ in scale. The neighborhood similarity tool normalizes these metrics between cities in order to create accurate comparisons. For example, the average rent in a cheap New York City neighborhood may be the same as the average rent in the most expensive neighborhood of a smaller city. It would be incorrect to call these neighborhoods similar. A variety of techniques may be used to normalize these different metrics across neighborhoods. For example, when computing distances the neighborhood similarity tool computes distances using metrics, such as a walk score metric, a bike score metric, a transit score metric, a median income, a median rent, a population density, a job density, and/or social data metric. Of these, median income and median rent may not be directly comparable from city to city. To make median income and median rent comparable between cities, those metrics may be normalized by the median metrics in their cities. This has the effect of changing the median metric for all neighborhoods into a value that is a multiple of the containing city's median metric. For example, if a city has a median income of $50,000 and a set of neighborhoods have median incomes of $32,000, $40,000, $60,000, and $90,000. The scaled median incomes for those neighborhoods are 0.64, 0.8, 1.2, and 1.8, respectively.

At block 1206, similar data within each data set is identified by comparing metrics. In one embodiment, this may be achieved using pairwise distances computed by the computeCityToCityAddressDistances( ) function to determine the set of similar addresses between city1 and city2 by applying a threshold that separates similar from dissimilar. Table 3 illustrates example pseudocode.

TABLE 3
Pseudocode for Applying a Threshold

```
function getSimilarAddresses(city1, city2, threshold):
    similar = { } // The set of similar addresses.
    distances = computeCityToCityAddressDistances(city1, city2)
    for address1, address2, distance in distances:
        if distance <= threshold:
            similar += (address1, address2)
        endif
    endfor
    return similar
```

To compute the distance between all neighborhoods in one city versus another city, the distance computation function in Table 4 could be used.

TABLE 4
Pseudocode for Computing City-City Neighborhood Distances

```
function computeCityToCityNeighborhoodDistances(city1, city2):
    distances = { } // Stores neighborhood-neighborhood distance
mappings.
    foreach hood1 in city1.neighborhoods:
        foreach hood2 in city2.neighborhoods:
            distance = computeLocationPairDistance(hood1, hood2)
            distances[hood1 to hood2] = distance
        endfor
    return distances
```

There are multiple data points that can be compared for identified locations. Each data point is associated with some metric. The metrics may be used in their raw form or may be normalized to provide more accurate comparisons. Table 5 illustrates an example set of data points for comparing neighborhoods.

TABLE 5
Example Set of Data Points for Comparing Neighborhoods

```
-{
    -“raw_median_rent_to” : {
        “scaled” : 0.9964285714285714,
        - “raw” : {
            “count” : 80,
            “median_cost” : 1395
        }
      },
      “transitscore” : 82.19545293546427,
      “pop_per_point” : 100.85643731826649,
    - “raw_median_income” : {
          “median_income_to” : 36936.5,
          “median_income_from” : 48352.5,
          “scaled_median_income_to” : 0.8076023263949624,
          “scaled_median_income_from” : 0.8756179714239148
      },
      “jobs_per_point” : 0.6828652023829251,
      - “raw_median_rent_from” : {
          “scaled” : 0.9482014388489208,
        - “raw” : {
            “count” : 93,
            “median cost” : 3295
          }
        },
        “total” : 195.88375488600582,
        “scaled_median_income” : 16.3281026827578,
        “walkscore” : 12.72980707946353,
        “bikescore” : 0.23053004142627462,
        “scaled_median_rent” : 1.3808188036966804,
        “social” : −18.520259177452136
    }
```

Currently, real estate apps and sites may recommend similar homes or apartments to their users. For example, if a user is looking at a 3 bedroom 2 bathroom home that is 2,200 square feet and costs $250,000 the real estate app or site may recommend other homes with similar characteristics. These characteristics might include price, number of beds and baths, square footage, year built, amenities such as a pool, view, large yard, etc. and other metrics such as the floor area ratio of the home (footprint of the home to lot size), style of the home, age of the home, etc These characteristics may be referred to as home amenity similarities. However, the two seemingly similar houses or apartments could be located in very different types of neighborhoods, thereby, making the homes seem not similar to a user. The present neighborhood similarity tool uses a technique to discover which locations are actually similar to each other based not only on the home and/or apartment similarity, but also with respect to the locations of each. This technique thereby enhances the accuracy of recommendations for similar locations. The location of a home may be deemed similar based on the walk shed of the home (area reachable in a certain walking time), a radius around the home, the neighborhood the home is in, or the like. The pseudocode in Table 6 may be used to find homes that are similar to a specified home based on location similarity and home amenity similarity.

TABLE 6
Pseudocode for Comparing Similarity of Location and Home Amenity

```
function compareHomePairAmenityDistance(home1, home2):
    distance = 0
    foreach amenity in additiveAmenities:
      distance += scaledDifference(home1.amenity, home2.amenity)**2
    endfor
    foreach amenity in subtractiveAmenities:
        if amenity in home1 and amenity in home2:
            distance −= amenityContribution(amenity)**2
    return distance
function compareHomeToHomes(home, homes, locationThreshold,
amenityThreshold)
    similar = { } // The set of similar homes.
    for home2 in homes:
        locationDistance = computeLocationPairDistance(
            home.address, home2.address
        )
    amenityDistance = computeHomePairAmenityDistance(home,
    home2)
    if locationDistance <= locationThreshold and
        amenityDistance <= amenityThreshold:
        similar += home2
    endif
endfor
return similar
```

The compareHomeToHomes function may be used to find homes that are similar to a specified home based on location similarity and home amenity similarity. As with the location distance algorithms described above, home distance has some terms that add to the distance and some terms that subtract from the distance. For example, differences in square footage and number of bedrooms may add to the distance, and the presence of some amenities in both houses, such as a fireplace, could subtract from the distance. The closer the distance, the more similar the homes.

Once the set of data points is compared for the identified locations, the neighborhood similarity tool outputs the results. The output can take many different forms. The goal of the neighborhood similarity tool is to help people find new places to live that match the places they know or like or to help people find new places to visit that match places they have enjoyed in the past. A variety of visualizations and user interfaces may be used to help people find the similar places. FIGS. 13-17 illustrate example visual representations of results of the neighborhood similarity process illustrated in FIG. 2.

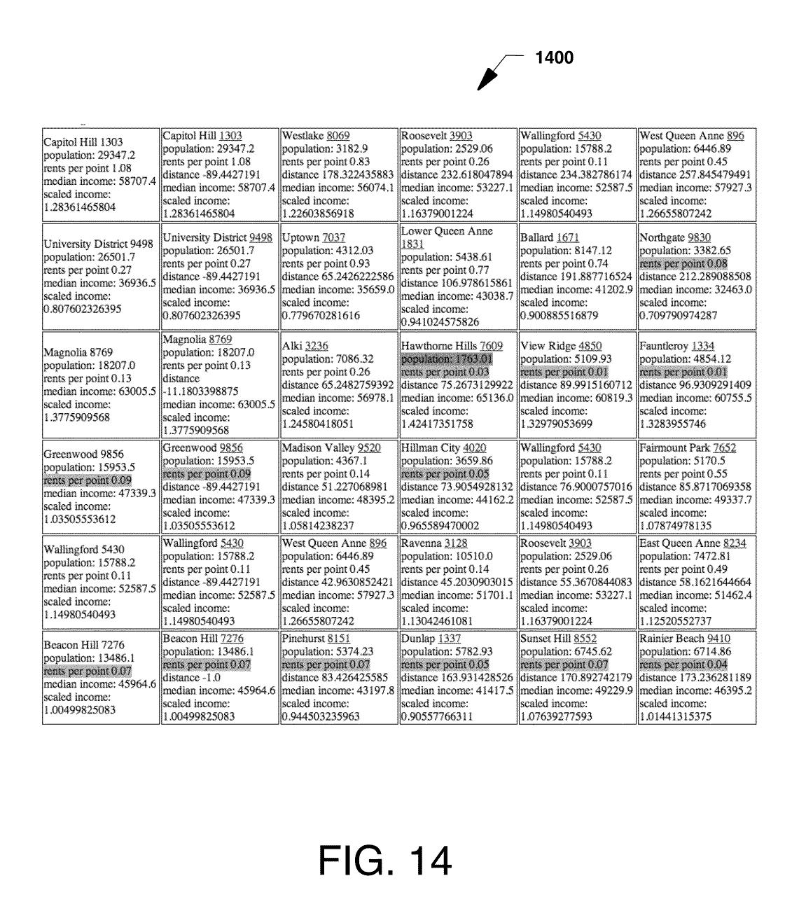

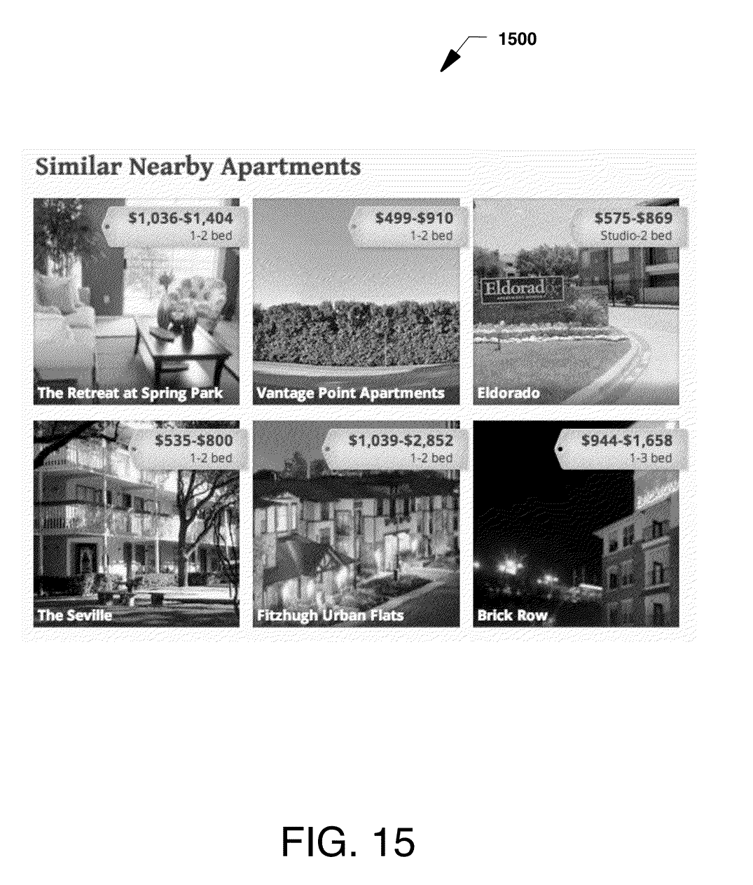

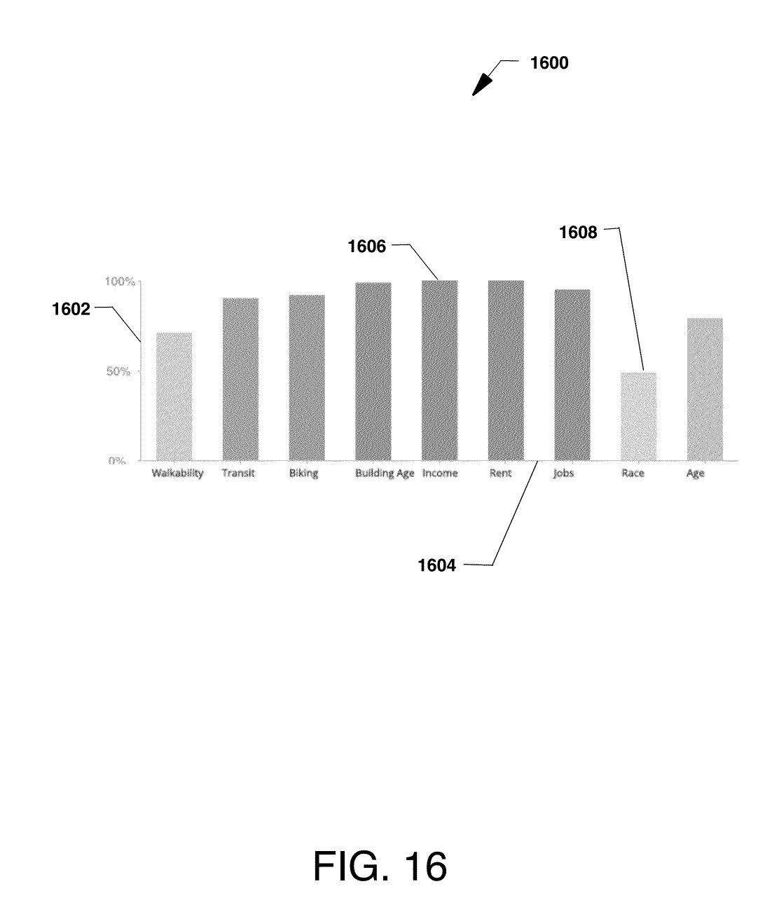

FIG. 13 illustrates an example table which is output and illustrates a subset of neighborhoods in San Francisco which are similar to neighborhoods in Seattle. In Table 1300, the following data points were analyzed: population, rents per point, median income, scaled income. As one skilled in the art will appreciate, any number of data points may be analyzed. FIG. 14 illustrates Table 1400 which shows the results of comparing neighborhoods within the same city (e.g., Seattle) based on several data points, such as population, rents per point, median income, scaled income, or the like. In another embodiment in which a user is viewing a home or apartment listing, similar nearby properties may be shown in a table, a list, etc. FIG. 15 is an example output illustrating similar nearby apartments selected by apartment properties (e.g., price/beds) and by location similarity. If a user is interested in one of the similar properties, the user may select the property to obtain additional information. FIG. 16 is an example output of a bar graph to represent dimensions on which two neighborhoods are most similar. The bar chart 1600 includes a y-axis 1602 indicating a percent and an x-axis 1604 for indicating different metrics. Multiple bars (e.g., bars 1606 and 1608) are displayed along the x-axis at various heights to indicate the corresponding percentage reflecting the similarity between the two locations. For example, bar 1606 represents income and indicates that the two locations are roughly 95% similar regarding this metric. Whereas bar 608 represents race and indicates that the two locations are roughly 50% similar regarding this metric. The bar chart 1600 allows individuals to readily interpret whether the locations are similar in the metrics in which they are interested. Other graphs and/or other visualizations may be used to show why properties or locations are similar. For example, another graph may include a bar for a set of neighborhoods so that the user can visually see which neighborhoods are most similar.

In another embodiment, the output may include a similarity score that is calculated based on similarities between neighborhoods. For example, neighborhoods that are almost identical might have a similarity score of 100 and neighborhoods that are completely different may have a score of 0. The similarity score may be based on a normalization of the Euclidean similarity distance calculated between neighborhoods and may be expressed as a number between 0-100, a percentage (e.g. 57% similar), a text label such as “very similar”, or the like. The similarity score may be determined by taking the Euclidean distance which is a raw number of arbitrary scale and transform it into a more understandable score between 0-100. For example, the range of distances may be split into three groups and scored conditionally: 1) score 100 if distance <0; 2) score computed by function if 0<=distance <upper; and 3) score 0 if upper <=distance. The upper argument may be the first distance value that is deemed to have a score of 0. One exemplary linear function to compute scores for the middle group is:
function compute Score(distance, upper):
   return 100−(distance/upper)*100
      Alternatively, a nonlinear function may be used, if appropriate. For example, a logarithmic scale may be used to normalize values that varied greatly in magnitude. These same techniques work equally well for comparing addresses (e.g., homes and apartments) or neighborhoods, cities, or other arbitrary areas.

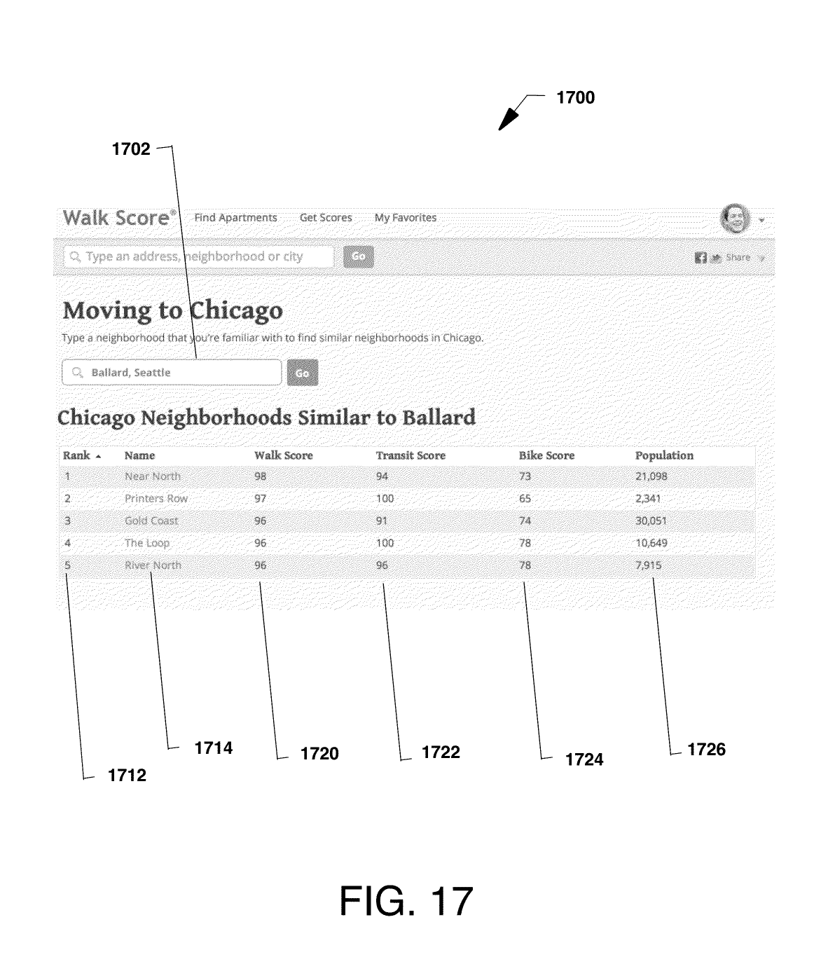

Some web and mobile applications know your “home” location based on past behavior (e.g. GPS traces or user-entered home and work locations). Mobile interfaces of this nature could automatically suggest similar neighborhoods when you are in a new place. For example, upon launch, a mobile app could detect your current location, compare that against your stored home location, and automatically select similar locations to visit in a new city. This scenario could be useful for traveling or home shopping. Search interfaces can be used to help people find neighborhoods similar to neighborhoods they know. For example, a website, web page, or app about moving to a city could allow a user to find neighborhoods in that city that are similar to neighborhoods that they are already know. FIG. 17 is an example output that includes a web page about moving to Chicago. The user may type a familiar neighborhood, such as Ballard or Seattle in an input field 1702. Using that input, the neighborhood similarity tool will display neighborhoods 1714 in Chicago that are similar to Ballard or Seattle. The displayed neighborhoods 1714 may be listed by a ranking 1712. Each neighborhood 1714 that is listed may have any number of associated metrics displayed in one or more fields, such as a walk score metric field 1720, a transit score metric field 1722, a bike score metric field 1724, a population metric field 1726, and the like. The user's location could automatically be detected via IP address or GPS or other means to show neighborhoods similar to their current location by default. This would allow the website or app to display similar neighborhoods without requiring user input. Cities could also be analyzed for similarity in this way. For example, the neighborhood similarity tool may output results showing which cities in Canada are most similar to cities in the United States. The neighborhood similarity tool may be incorporated into a travel application in order for the travel application to recommend places to travel. For example, if a user enjoyed traveling in Santa Marta, Columbia, the neighborhood similarity tool may recommend traveling to Morro de Sao Paulo, Brazil. A multi-dimensional analysis of cities with the neighborhood similarity tool operates in the same manner as a multi-dimensional analysis neighborhoods, but just uses a larger geographic area. For example, the boundaries of an “incorporated place” provided by the U.S. census.

While the foregoing written description of the invention enables one of ordinary skill to make and use a neighborhood similarity tool as described above, those of ordinary skill will understand and appreciate the existence of variations, combinations, and equivalents of the described embodiments, methods, and examples herein. Thus, the invention as claimed should therefore not be limited by the above described embodiments, methods, and examples, but by all embodiments and methods within the scope and spirit of the claimed invention.

The claimed invention is:

1. A system for comparing similarity of locations, the system comprising:
a memory for storing computer-readable instructions associated with a neighborhood similarity tool; and
a processor programmed to execute the computer-readable instructions to enable the neighborhood similarity tool, wherein when the computer-readable instructions are executed, the system is programmed to:
obtain a first and second location;
determine a first and second area corresponding to the first and second location, respectively;
obtain metrics relevant to characteristics that create a unique character for the first and second location, wherein the characteristics include features reflecting location similarity and features reflecting home amenity similarity;
compare the metrics to determine a similarity assessment between the first and second location; and
output the similarity assessment.

2. The system of claim 1, wherein the features reflecting location similarity includes at least one assessment score.

3. The system of claim 2, wherein the at least one assessment score includes a walk score metric, a transit score metric, a bike score metric, or a crime score metric.

4. The system of claim 1, wherein the features reflecting location similarity includes at least one nearby business assessment reflecting types of businesses in the first and second area.

5. The system of claim 1, wherein the features reflecting location similarity includes at least one job-related assessment.

6. The system of claim 1, wherein the features reflecting location similarity includes at least one people-related assessment.

7. The system of claim 1, wherein the features reflecting location similarity includes at least one social media assessment.

8. The system of claim 1, wherein comparing the metrics to determine a similarity assessment between the first and second location includes determining a pairwise distance between multidimensional data points for the two locations, wherein each metric represents one dimension point.

9. The system of claim 8, further comprising normalizing at least one metric.

10. A computer-implemented method for displaying similarity between locations, the computer-implemented method comprising:
providing a first location to a neighborhood similarity tool;
receiving a similarity assessment from the neighborhood similarity tool, wherein the similarity assessment is based on metrics relevant to characteristics that create a unique character for the first location and a second location, wherein the characteristics include features reflecting location similarity and features reflecting home amenity similarity; and
graphically displaying the similarity assessment on a computing device display.

11. The computer-implemented method of claim 10, wherein the first location is entered as input via the neighborhood similarity tool.

12. The computer-implemented method of claim 10, wherein the first location is automatically provided to the neighborhood similarity tool based on a current location identified by a GPA-cable device.

13. The computer-implemented method of claim 10, wherein the first location represents a current home location and the second location represents a new home location.

14. The computer-implemented method of claim 10, wherein the first location represents a previously traveled location and second location represents a new travel location determined by the neighborhood similarity tool.

15. The computer-implemented method of claim 10, wherein graphically displaying the similarity assessment on a computing device display includes a table including a subset of neighborhoods in a first location similar to neighborhoods in a second location based on the metrics.

16. The computer-implemented method of claim 15, wherein the first location and second location represent neighborhoods within the same city.

17. The computer-implemented method of claim 10, wherein graphically displaying the similarity assessment on a computing device display includes a bar graph representing dimensions on which the two locations are most similar.

18. The computer-implemented method of claim 10, wherein graphically displaying the similarity assessment on a computing device display includes displaying the similarity assessment using a percentage reflective of the similarity between a metric generated for the first and for the second location.

19. The computer-implemented method of claim 10, wherein the metrics include at least one from a set including a walk score metric, a transit score metric, a bike score metric, and a population metric.

20. A computer-readable media storing computer-readable components executable by a computing device, the computer-readable components comprising:
a neighborhood similarity component configured to compute a similarity assessment between a first location and a second location based on metrics relevant to characteristics that create a unique character for the first location and the second location, wherein the characteristics include features reflecting location similarity and features reflecting home amenity similarity; and
an output component to output the similarity assessment to allow a graphical representation of the similarity assessment on a display of a computing device.
